(19) United States
(12) Patent Application Publication
(10) Pub. No.: US 2021/0076449 A1
(43) Pub. Date: Mar. 11, 2021

(54) OFFLINE DISCONTINUOUS RECEPTION PROCEDURE

(71) Applicant: QUALCOMM Incorporated, San Diego, CA (US)

(72) Inventors: Vijayvaradharaj TIRUCHERAI MURALIDHARAN, Santa Clara, CA (US); Ahmed ZAKI, Bengaluru (IN); Alberto RICO ALVARINO, San Diego, CA (US); Le LIU, Fremont, CA (US); Hemanth S., Kurnool (IN); Arvind SRIDHARAN, Bangalore (IN); Murali MENON, Acton, MA (US)

(21) Appl. No.: 16/947,906

(22) Filed: Aug. 24, 2020

(30) Foreign Application Priority Data
Sep. 6, 2019 (IN) 201941036065

(51) Int. Cl. H04W 76/28; H04W 68/00; H04W 72/04; H04B 1/713

(52) U.S. Cl. CPC H04W 76/28; H04B 1/713; H04W 72/042; H04W 68/005

(57) ABSTRACT

Various aspects of the present disclosure generally relate to wireless communication. In some aspects, a user equipment (UE) may receive a configuration that identifies one or more narrowband channels in which the UE is to receive one or more physical downlink shared channel (PDSCH) repetitions of a paging message associated with a discontinuous reception procedure. The UE may receive, in an online mode of the UE, one or more machine-type communication physical downlink control channel (MPDCCH) repetitions of control information. The UE may receive, in the online mode of the UE, the one or more PDSCH repetitions in the one or more narrowband channels identified by the configuration. The UE may process, in an offline mode of the UE, the one or more MPDCCH repetitions and the one or more PDSCH repetitions. Numerous other aspects are provided.

### CROSS-REFERENCE TO RELATED APPLICATION

This patent application claims priority to India Patent Application No. 201941036065, filed on Sep. 6, 2019, entitled “OFFLINE DISCONTINUOUS RECEPTION PROCEDURE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for an offline discontinuous reception (DRX) procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a UE, may include receiving a configuration that identifies one or more narrowband channels in which the UE is to receive one or more physical downlink shared channel (PDSCH) repetitions of a paging message associated with a discontinuous reception procedure; receiving, in an online mode of the UE, one or more machine-type communication physical downlink control channel (MPDCCH) repetitions of control information; receiving, in the online mode of the UE, the one or more PDSCH repetitions in the one or more narrowband channels identified by the configuration; and processing, in an offline mode of the UE, the one or more MPDCCH repetitions and the one or more PDSCH repetitions.

In some aspects, a method of wireless communication, performed by a base station, may include transmitting a configuration that identifies one or more narrowband channels in which a UE is to receive one or more PDSCH repetitions of a paging message associated with a discontinuous reception procedure; transmitting one or more MPDCCH repetitions of control information; and transmitting the one or more PDSCH repetitions in the one or more narrowband channels identified by the configuration.

In some aspects, a UE for wireless communication may include memory and one or more processors operatively coupled to the memory. The memory and the one or more processors may be configured to receive a configuration that identifies one or more narrowband channels in which the UE is to receive one or more PDSCH repetitions of a paging message associated with a discontinuous reception procedure; receive, in an online mode of the UE, one or more MPDCCH repetitions of control information; receive, in the online mode of the UE, the one or more PDSCH repetitions in the one or more narrowband channels identified by the configuration; and process, in an offline mode of the UE, the one or more MPDCCH repetitions and the one or more PDSCH repetitions.

In some aspects, a base station for wireless communication may include memory and one or more processors operatively coupled to the memory. The memory and the one or more processors may be configured to transmit a configuration that identifies one or more narrowband channels in which a UE is to receive one or more PDSCH repetitions of a paging message associated with a discontinuous reception procedure; transmit one or more MPDCCH repetitions of control information; and transmit the one or more PDSCH repetitions in the one or more narrowband channels identified by the configuration.

In some aspects, a non-transitory computer-readable medium may store one or more instructions for wireless communication. The one or more instructions, when executed by one or more processors of a UE, may cause the one or more processors to: receive a configuration that identifies one or more narrowband channels in which the UE is to receive one or more PDSCH repetitions of a paging message associated with a discontinuous reception procedure; receive, in an online mode of the UE, one or more MPDCCH repetitions of control information; receive, in the online mode of the UE, the one or more PDSCH repetitions in the one or more narrowband channels identified by the configuration; and process, in an offline mode of the UE, the one or more MPDCCH repetitions and the one or more PDSCH repetitions.

In some aspects, a non-transitory computer-readable medium may store one or more instructions for wireless communication. The one or more instructions, when executed by one or more processors of a base station, may cause the one or more processors to: transmit a configuration that identifies one or more narrowband channels in which a UE is to receive one or more PDSCH repetitions of a paging message associated with a discontinuous reception procedure; transmit one or more MPDCCH repetitions of control information; and transmit the one or more PDSCH repetitions in the one or more narrowband channels identified by the configuration.

In some aspects, an apparatus for wireless communication may include means for receiving a configuration that identifies one or more narrowband channels in which the apparatus is to receive one or more PDSCH repetitions of a paging message associated with a discontinuous reception procedure; means for receiving, in an online mode of the apparatus, one or more MPDCCH repetitions of control information; means for receiving, in the online mode of the apparatus, the one or more PDSCH repetitions in the one or more narrowband channels identified by the configuration; and means for processing, in an offline mode of the apparatus, the one or more MPDCCH repetitions and the one or more PDSCH repetitions.

In some aspects, an apparatus for wireless communication may include means for transmitting a configuration that identifies one or more narrowband channels in which a UE is to receive one or more PDSCH repetitions of a paging message associated with a discontinuous reception procedure; means for transmitting one or more MPDCCH repetitions of control information; and means for transmitting the one or more PDSCH repetitions in the one or more narrowband channels identified by the configuration.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3A is a block diagram conceptually illustrating an example of a frame structure in a wireless communication network, in accordance with various aspects of the present disclosure.

FIG. 3B is a block diagram conceptually illustrating an example synchronization communication hierarchy in a wireless communication network, in accordance with various aspects of the present disclosure.

FIG. 4 is a block diagram conceptually illustrating an example slot format with a normal cyclic prefix, in accordance with various aspects of the present disclosure.

FIG. 5 is a diagram illustrating an example of an offline DRX procedure, in accordance with various aspects of the present disclosure.

FIG. 6 is a diagram illustrating an example process performed, for example, by a UE, in accordance with various aspects of the present disclosure.

FIG. 7 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

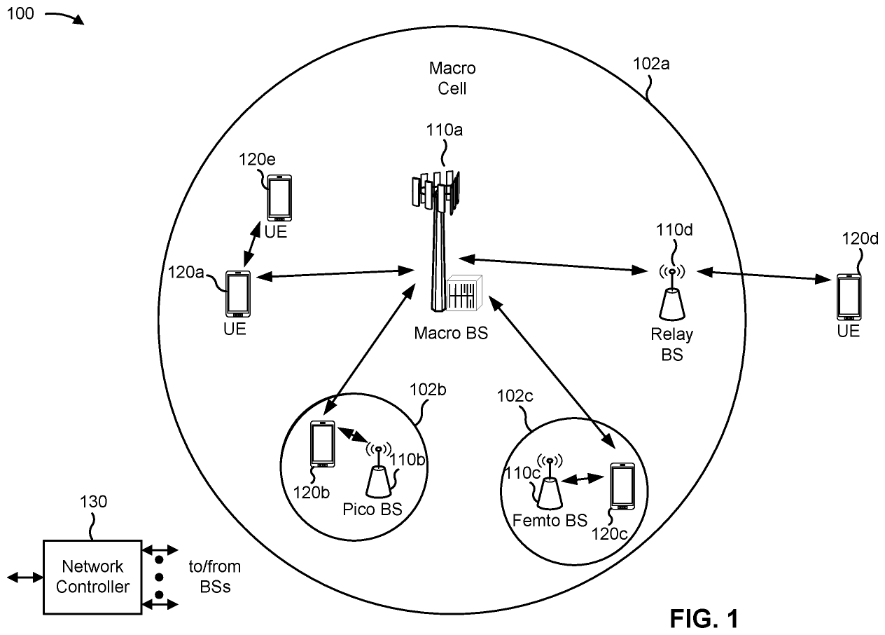

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

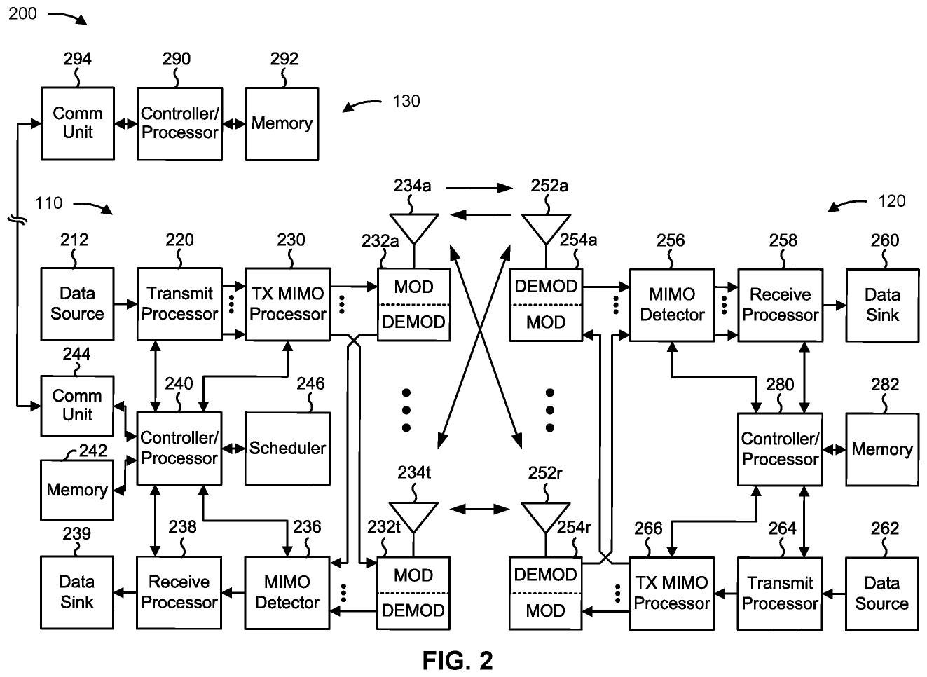

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

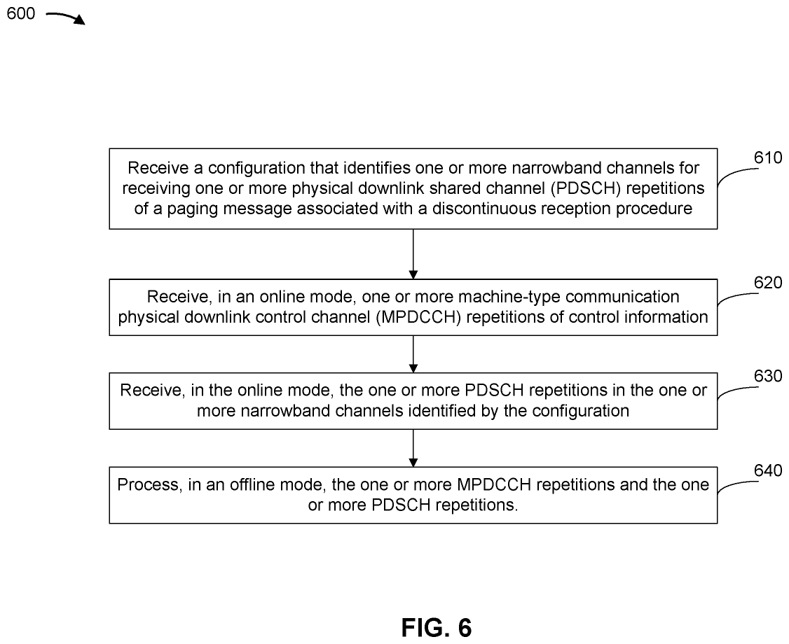

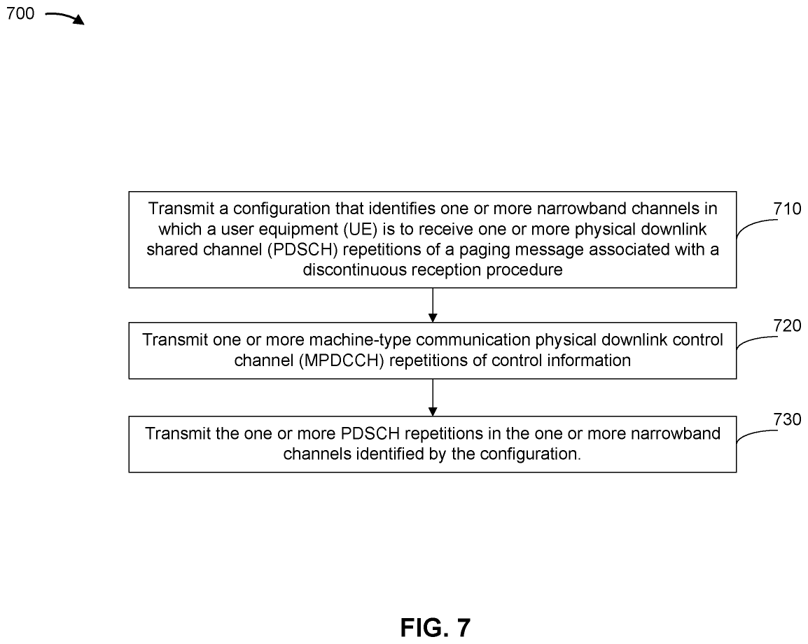

Controller/processor 240 of base station 110, controller/processor 280 of UE 120, and/or any other component(s) of FIG. 2 may perform one or more techniques associated with an offline DRX procedure, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 600 of FIG. 6, process 700 of FIG. 7, and/or other processes as described herein. A scheduler 246 may schedule UEs for data transmission on the downlink and/or uplink.

In some aspects, UE 120 may include means for receiving (e.g., using antenna 252, DEMOD 254, MIMO detector 256, receive processor 258, controller/processor 280, memory 282, and/or the like) a configuration that identifies one or more narrowband channels in which UE 120 is to receive one or more PDSCH repetitions of a paging message associated with a discontinuous reception procedure, means for receiving (e.g., using antenna 252, DEMOD 254, MIMO detector 256, receive processor 258, controller/processor 280, memory 282, and/or the like), in an online mode of UE 120, one or more MPDCCH repetitions of control information, means for receiving (e.g., using antenna 252, DEMOD 254, MIMO detector 256, receive processor 258, controller/processor 280, memory 282, and/or the like), in the online mode of UE 120, the one or more PDSCH repetitions in the one or more narrowband channels identified by the configuration, means for processing (e.g., using controller/processor 280, memory 282, and/or the like), in an offline mode of UE 120, the one or more MPDCCH repetitions and the one or more PDSCH repetitions, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting (e.g., using transmit processor 220, TX MIMO processor 230, modulator 232, antenna 234, controller/processor 240, memory 242, scheduler 246, and/or the like) a configuration that identifies one or more narrowband channels in which a UE is to receive one or more PDSCH repetitions of a paging message associated with a discontinuous reception procedure, means for transmitting (e.g., using transmit processor 220, TX MIMO processor 230, modulator 232, antenna 234, controller/processor 240, memory 242, scheduler 246, and/or the like) one or more MPDCCH repetitions of control information, means for transmitting (e.g., using transmit processor 220, TX MIMO processor 230, modulator 232, antenna 234, controller/processor 240, memory 242, scheduler 246, and/or the like) the one or more PDSCH repetitions in the one or more narrowband channels identified by the configuration, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

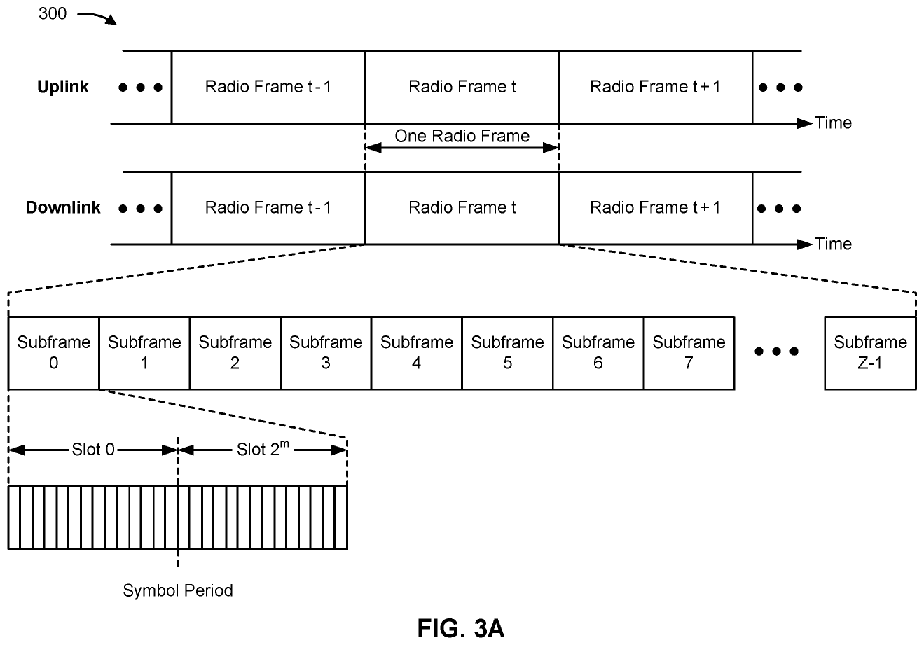

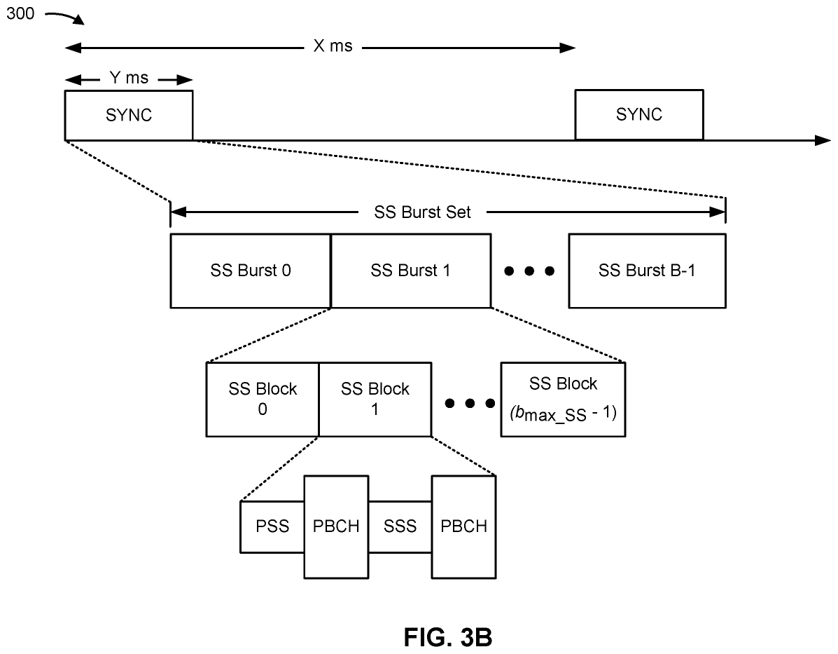

FIG. 3A shows an example frame structure 300 for frequency division duplexing (FDD) in a telecommunications system (e.g., NR). The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z−1). Each subframe may have a predetermined duration (e.g., 1 ms) and may include a set of slots (e.g., 2^{m} slots per subframe are shown in FIG. 3A, where m is a numerology used for a transmission, such as 0, 1, 2, 3, 4, and/or the like). Each slot may include a set of L symbol periods. For example, each slot may include fourteen symbol periods (e.g., as shown in FIG. 3A), seven symbol periods, or another number of symbol periods. In a case where the subframe includes two slots (e.g., when m=1), the subframe may include 2L symbol periods, where the 2L symbol periods in each subframe may be assigned indices of 0 through 2L−1. In some aspects, a scheduling unit for the FDD may be frame-based, subframe-based, slot-based, symbol-based, and/or the like.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, “wireless communication structure” may refer to a periodic time-bounded communication unit defined by a wireless communication standard and/or protocol. Additionally, or alternatively, different configurations of wireless communication structures than those shown in FIG. 3A may be used.

In certain telecommunications (e.g., NR), a base station may transmit synchronization signals. For example, a base station may transmit a primary synchronization signal (PSS), a secondary synchronization signal (SSS), and/or the like, on the downlink for each cell supported by the base station. The PSS and SSS may be used by UEs for cell search and acquisition. For example, the PSS may be used by UEs to determine symbol timing, and the SSS may be used by UEs to determine a physical cell identifier, associated with the base station, and frame timing. The base station may also transmit a physical broadcast channel (PBCH). The PBCH may carry some system information, such as system information that supports initial access by UEs.

In some aspects, the base station may transmit the PSS, the SSS, and/or the PBCH in accordance with a synchronization communication hierarchy (e.g., a synchronization signal (SS) hierarchy) including multiple synchronization communications (e.g., SS blocks), as described below in connection with FIG. 3B.

FIG. 3B is a block diagram conceptually illustrating an example SS hierarchy, which is an example of a synchronization communication hierarchy. As shown in FIG. 3B, the SS hierarchy may include an SS burst set, which may include a plurality of SS bursts (identified as SS burst 0 through SS burst B−1, where B is a maximum number of repetitions of the SS burst that may be transmitted by the base station). As further shown, each SS burst may include one or more SS blocks (identified as SS block 0 through SS block (b_{max_SS}−1), where b_{max_SS}−1 is a maximum number of SS blocks that can be carried by an SS burst). In some aspects, different SS blocks may be beam-formed differently. An SS burst set may be periodically transmitted by a wireless node, such as every X milliseconds, as shown in FIG. 3B. In some aspects, an SS burst set may have a fixed or dynamic length, shown as Y milliseconds in FIG. 3B.

The SS burst set shown in FIG. 3B is an example of a synchronization communication set, and other synchronization communication sets may be used in connection with the techniques described herein. Furthermore, the SS block shown in FIG. 3B is an example of a synchronization communication, and other synchronization communications may be used in connection with the techniques described herein.

In some aspects, an SS block includes resources that carry the PSS, the SSS, the PBCH, and/or other synchronization signals (e.g., a tertiary synchronization signal (TSS)) and/or synchronization channels. In some aspects, multiple SS blocks are included in an SS burst, and the PSS, the SSS, and/or the PBCH may be the same across each SS block of the SS burst. In some aspects, a single SS block may be included in an SS burst. In some aspects, the SS block may be at least four symbol periods in length, where each symbol carries one or more of the PSS (e.g., occupying one symbol), the SSS (e.g., occupying one symbol), and/or the PBCH (e.g., occupying two symbols).

In some aspects, the symbols of an SS block are consecutive, as shown in FIG. 3B. In some aspects, the symbols of an SS block are non-consecutive. Similarly, in some aspects, one or more SS blocks of the SS burst may be transmitted in consecutive radio resources (e.g., consecutive symbol periods) during one or more slots. Additionally, or alternatively, one or more SS blocks of the SS burst may be transmitted in non-consecutive radio resources.

In some aspects, the SS bursts may have a burst period, whereby the SS blocks of the SS burst are transmitted by the base station according to the burst period. In other words, the SS blocks may be repeated during each SS burst. In some aspects, the SS burst set may have a burst set periodicity, whereby the SS bursts of the SS burst set are transmitted by the base station according to the fixed burst set periodicity. In other words, the SS bursts may be repeated during each SS burst set.

The base station may transmit system information, such as system information blocks (SIBs) on a physical downlink shared channel (PDSCH) in certain slots. The base station may transmit control information/data on a physical downlink control channel (PDCCH) in C symbol periods of a slot, where B may be configurable for each slot. The base station may transmit traffic data and/or other data on the PDSCH in the remaining symbol periods of each slot.

As indicated above, FIGS. 3A and 3B are provided as examples. Other examples may differ from what is described with regard to FIGS. 3A and 3B.

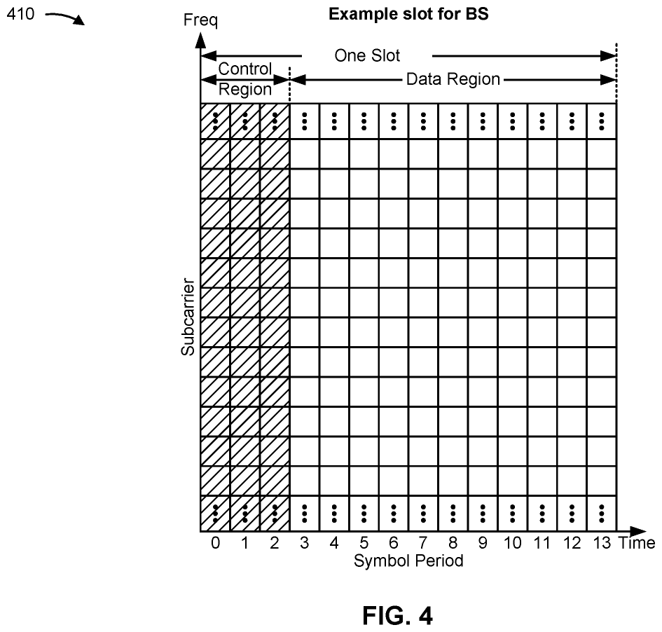

FIG. 4 shows an example slot format 410 with a normal cyclic prefix. The available time frequency resources may be partitioned into resource blocks. Each resource block may cover a set of subcarriers (e.g., 12 subcarriers) in one slot and may include a number of resource elements. Each resource element may cover one subcarrier in one symbol period (e.g., in time) and may be used to send one modulation symbol, which may be a real or complex value.

An interlace structure may be used for each of the downlink and uplink for FDD in certain telecommunications systems (e.g., NR). For example, Q interlaces with indices of 0 through Q−1 may be defined, where Q may be equal to 4, 6, 8, 10, or some other value. Each interlace may include slots that are spaced apart by Q frames. In particular, interlace q may include slots q, q+Q, q+2Q, etc., where q∈{0, . . . , Q−1}.

A UE may be located within the coverage of multiple BSs. One of these BSs may be selected to serve the UE. The serving BS may be selected based at least in part on various criteria such as received signal strength, received signal quality, path loss, and/or the like. Received signal quality may be quantified by a signal-to-noise-and-interference ratio (SNIR), or a reference signal received quality (RSRQ), or some other metric. The UE may operate in a dominant interference scenario in which the UE may observe high interference from one or more interfering BSs.

While aspects of the examples described herein may be associated with NR or 5G technologies, aspects of the present disclosure may be applicable with other wireless communication systems. New Radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). In aspects, NR may utilize OFDM with a CP (herein referred to as cyclic prefix OFDM or CP-OFDM) and/or SC-FDM on the uplink, may utilize CP-OFDM on the downlink and include support for half-duplex operation using time division duplexing (TDD). In aspects, NR may, for example, utilize OFDM with a CP (herein referred to as CP-OFDM) and/or discrete Fourier transform spread orthogonal frequency-division multiplexing (DFT-s-OFDM) on the uplink, may utilize CP-OFDM on the downlink and include support for half-duplex operation using TDD. NR may include Enhanced Mobile Broadband (eMBB) service targeting wide bandwidth (e.g., 80 megahertz (MHz) and beyond), millimeter wave (mmW) targeting high carrier frequency (e.g., 60 gigahertz (GHz)), massive MTC (mMTC) targeting non-backward compatible MTC techniques, and/or mission critical targeting ultra reliable low latency communications (URLLC) service.

In some aspects, a single component carrier bandwidth of 100 MHz may be supported. NR resource blocks may span 12 sub-carriers with a sub-carrier bandwidth of 60 or 120 kilohertz (kHz) over a 0.1 millisecond (ms) duration. Each radio frame may include 40 slots and may have a length of 10 ms. Consequently, each slot may have a length of 0.25 ms. Each slot may indicate a link direction (e.g., DL or UL) for data transmission and the link direction for each slot may be dynamically switched. Each slot may include DL/UL data as well as DL/UL control data.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such as central units or distributed units.

As indicated above, FIG. 4 is provided as an example. Other examples may differ from what is described with regard to FIG. 4.

An eMTC UE may perform a DRX procedure in order to reduce power consumption. According to a DRX procedure, a UE may periodically transfer from a wake state, during which the UE may communicate with a base station, to a sleep state, during which the UE may refrain from communicating with the base station, thereby reducing power consumption. In current wireless communication systems, an eMTC UE may perform an online DRX procedure, in which the UE, in an online mode (e.g., a wake state), may perform a warm-up operation during a first interval (e.g., upon waking from a sleep state). In the warm-up operation, the UE may attempt to latch to a particular frequency and/or timing used by the base station, perform automatic gain control operations, perform channel estimation operations, and/or the like. During a second interval, the UE may receive one or more MPDCCH repetitions of control information from the base station. The UE may process (e.g., decode) the one or more MPDCCH repetitions during the second interval and/or during a third interval (e.g., a guard interval) to identify a location of one or more PDSCH repetitions of a paging message of the DRX procedure. During a fourth interval, the UE may receive the one or more PDSCH repetitions and process (e.g., decode) the one or more PDSCH repetitions to obtain the paging message.

A UE may further reduce power consumption by performing an offline DRX procedure, in which the UE, in an offline mode (e.g., a sleep state), may process the one or more MPDCCH repetitions and/or the one or more PDSCH repetitions received by the UE. However, in eMTC, the one or more MPDCCH repetitions and the one or more PDSCH repetitions may not be located in the same narrowband channels. In such a case, an eMTC UE cannot locate the one or more PDSCH repetitions without first processing the one or more MPDCCH repetitions. Accordingly, in eMTC, the UE cannot process the one or more MPDCCH repetitions and the one or more PDSCH repetitions in an offline mode, thereby increasing power consumption of the UE.

Techniques and apparatuses described herein provide an offline DRX procedure for an eMTC UE. For example, in some aspects, a UE may receive a configuration that identifies a location of one or more PDSCH repetitions of a paging message. In this way, the UE may receive the one or more PDSCH repetitions without first processing one or more MPDCCH repetitions in order to identify the location of the one or more PDSCH repetitions. Accordingly, the UE may process the one or more MPDCCH repetitions and the one or more PDSCH repetitions in an offline mode (e.g., a sleep state), thereby conserving power resources of the UE.

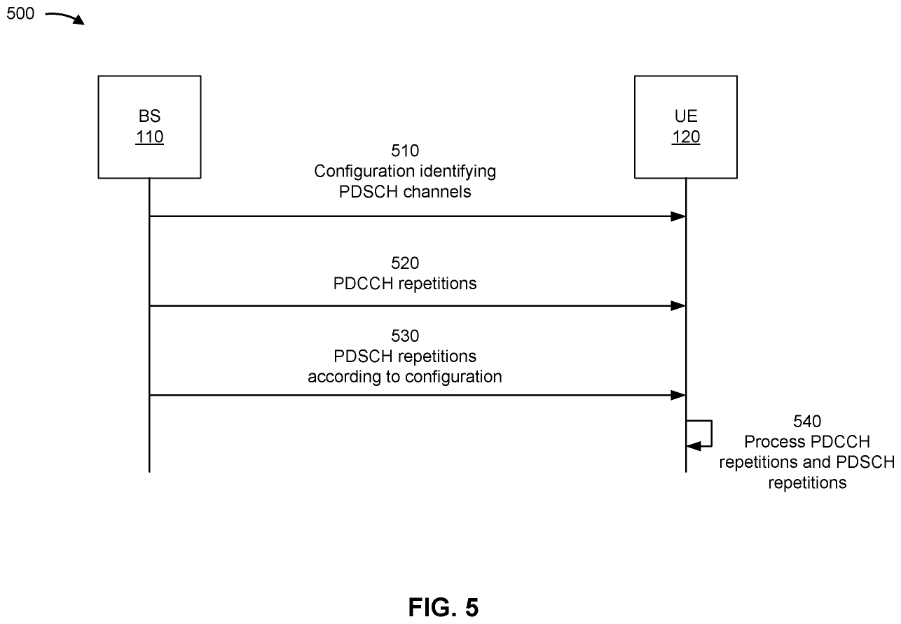

FIG. 5 is a diagram illustrating an example 500 of an offline DRX procedure, in accordance with various aspects of the present disclosure. As shown in FIG. 5, a BS 110 may communicate with a UE 120. The UE 120 may be associated with MTC or eMTC (e.g., the UE 120 may be an MTC UE or an eMTC UE). While example 500 will be described in terms of a paging message, the techniques and apparatuses described herein apply equally to other types of messages that may be received via a PDSCH, such as a message 2 communication or a message 4 communication of a random access channel (RACH) procedure (e.g., when the UE 120 is associated with a low coverage level, such as a coverage level of 1 or 2). Additionally, while example 500 will be described in terms of FDD communication, the techniques and apparatuses described herein apply equally to TDD communication.

As shown by reference number 510, the BS 110 may transmit, and the UE 120 may receive, a configuration that identifies one or more channels (e.g., narrowband channels) for locating one or more PDSCH repetitions of a paging message. In some aspects, the UE may receive a static configuration that identifies the channels for locating the PDSCH repetitions. Additionally, or alternatively, the UE may receive a semi-static configuration (e.g., via a system information block, radio resource control (RRC) signaling, and/or the like) that identifies the channels for locating the PDSCH repetitions. In some aspects, the configuration that identifies the channels for locating the PDSCH repetitions may be communicated to the UE 120 by any other procedure, provided that the configuration is not communicated to the UE 120 in PDCCH repetitions (e.g., MPDCCH repetitions) associated with the PDSCH repetitions (e.g., the channels for locating the PDSCH repetitions are not indicated by a payload of an MPDCCH).

In some aspects, the configuration may identify one or more particular channels for locating the PDSCH repetitions. For example, the configuration may identify the particular channels by a channel identifier, by a frequency (e.g., a center frequency), and/or the like. In some aspects, the configuration may identify the channels for locating the PDSCH repetitions by reference to a PDCCH configuration that identifies one or more channels for locating one or more PDCCH repetitions (e.g., MPDCCH repetitions) of control information. For example, the configuration may indicate that the channels for locating the PDSCH repetitions are the same as the channels for locating the PDCCH repetitions (e.g., as indicated in the PDCCH configuration). As another example, the configuration may indicate that the channels for locating the PDSCH repetitions have a particular offset from the channels for locating the PDCCH repetitions (e.g., as indicated in the PDCCH configuration). The offset may be a numerical offset relating to channel identifiers, a frequency offset relating to a channel frequency (e.g., a center frequency), and/or the like. As a further example, the configuration may provide a formula that the UE 120 may use to determine the channels for locating the PDSCH repetitions.

In some aspects, prior to, or after, the UE 120 receives the configuration, the BS 110 and/or the UE 120 may report an offline DRX capability. In some cases, the BS 110 may advertise that offline DRX is supported by the BS 110 and the UE 120 may report to the BS 110 that the UE 120 is capable of performing offline DRX. In such cases, the channels for the locating the one or more PDSCH repetitions identified by the configuration may be different from channels that are to be used by a UE, that did not report offline DRX capability, for locating PDSCH repetitions. Accordingly, the BS 110 may transmit PDSCH repetitions in different resources for offline DRX-capable UEs (e.g., according to the configuration) and offline DRX-incapable UEs. Moreover, the UE 120 may determine resources (e.g., a paging frame, a paging offset, and/or the like) in which to receive the PDSCH repetitions (e.g., based at least in part on the configuration) using a procedure that is different from a procedure (e.g., a legacy procedure) used by a UE that did not report offline DRX capability. In some aspects, the PDSCH repetitions may be associated with a broadcast message (e.g., a broadcast paging message) intended for all UEs, or a subset thereof, that have reported offline DRX capability.

In some aspects, the BS 110 may advertise that offline DRX is supported by the BS 110 without receiving a report from the UE 120 relating to an offline DRX capability of the UE 120. In such cases, the channels for locating the PDSCH repetitions, identified by the configuration, may be the same as channels that are to be used by a UE, that did not report offline DRX capability, for locating PDSCH repetitions. Accordingly, the BS 110 may transmit PDSCH repetitions in the same resources for offline DRX-capable UEs and offline DRX-incapable UEs (e.g., according to the configuration). Moreover, the UE 120 may determine resources (e.g., a paging frame, a paging offset, and/or the like) in which to receive the PDSCH repetitions (e.g., based at least in part on the configuration) using a procedure that is the same as a procedure (e.g., a legacy procedure) used by a UE that did not report offline DRX capability.

In some aspects, the UE 120 may report to the BS 110 that the UE 120 is capable of performing offline DRX without receiving an advertisement that offline DRX is supported by the BS 110. In such cases, the BS 110 may transmit PDSCH repetitions according to the configuration when a group of UEs that are to receive the PDSCH repetitions are offline DRX capable.

In some aspects, the BS 110 may enable offline DRX processing for the UE 120 in a system information block or RRC signaling. In some aspects, the BS 110 and/or the UE 120 may determine whether to enable offline DRX processing. For example, the BS 110 and/or the UE 120 may determine to enable offline DRX processing based at least in part on a determination that a quantity (e.g., a maximum quantity) of the PDCCH repetitions and/or a quantity (e.g., a maximum quantity) of the PDSCH repetitions (e.g., as indicated by a DRX configuration transmitted by the BS 110 and received by the UE 120) satisfy a first threshold value (e.g., are less than a first threshold value). Additionally, or alternatively, the BS 110 and/or the UE 120 may determine to enable offline DRX processing based at least in part on a determination that a quantity of the PDCCH repetitions and/or a quantity of the PDSCH repetitions satisfy a second threshold value (e.g., are greater than a second threshold value). For example, the BS 110 and/or the UE 120 may determine to enable offline DRX processing based at least in part on a determination that a quantity of the PDCCH repetitions and/or a quantity of the PDSCH repetitions are within a threshold range.

As shown by reference number 520, the BS 110 may transmit, and the UE 120 may receive, one or more PDCCH (e.g., MPDCCH) repetitions of control information (e.g., downlink control information). The UE 120 may receive the PDCCH repetitions according to a PDCCH configuration, as described above. For example, the PDCCH configuration may identify one or more channels (e.g., narrowband channels) for locating the PDCCH repetitions.

In some aspects, the UE 120 may receive the PDCCH repetitions in an online mode of the UE 120, and may store the PDCCH repetitions in a memory (e.g., a buffer) of the UE 120. That is, the UE 120 may store the PDCCH repetitions for processing (e.g., decoding) when the UE 120 is in an offline mode. Accordingly, the UE 120 may ignore a portion (if present) of the control information of the PDCCH repetitions that identifies channels for locating the PDSCH repetitions.

As shown by reference number 530, the BS 110 may transmit, and the UE 120 may receive, one or more PDSCH repetitions of a paging message of a DRX procedure. For example, the UE 120 may receive the PDSCH repetitions of the paging message in the channels identified by the configuration (e.g., when the BS 110 has indicated that offline DRX is supported and/or when the UE 120 has offline DRX enabled). In some aspects, the PDCCH repetitions and the PDSCH repetitions may not be separated by a guard interval.

In some aspects, the UE 120 may receive the PDSCH repetitions in an online mode of the UE, and may store the PDSCH repetitions in a memory (e.g., a buffer) of the UE 120. That is, the UE 120 may store the PDSCH repetitions for processing (e.g., decoding) when the UE 120 is in an offline mode.

In some aspects, the PDSCH repetitions received by the UE 120 may be multiplexed with the PDCCH repetitions (e.g., MPDCCH repetitions) received by the UE 120 (e.g., in the same set of subframes, rather than the PDSCH beginning two subframes after an end of the MPDCCH). For example, if a quantity of the PDCCH repetitions is greater than a quantity of the PDSCH repetitions, a portion of the PDCCH repetitions may be multiplexed with the PDSCH repetitions (e.g., in one or more subframes). As another example, if a quantity of the PDSCH repetitions is greater than a quantity of the PDCCH repetitions, a portion of the PDSCH repetitions may be multiplexed with the PDCCH repetitions (e.g., in one or more subframes). In some aspects, a PDCCH repetition and a PDSCH repetition may be multiplexed in different (i.e., non-overlapping) resource blocks (e.g., multiplexed in frequency). In some aspects, a PDCCH repetition and a PDSCH repetition may be multiplexed in different symbols or different resource elements within a same resource block (e.g., multiplexed in time). For example, a PDCCH repetition may be located in a control region of a subframe (e.g., a first set of symbols of a subframe) and a PDSCH repetition may be located in a data region of the subframe (e.g., a second set of symbols of the subframe). In this way, multiplexing of the PDCCH repetitions and the PDSCH repetitions reduces storage usage for offline processing of the PDCCH repetitions and the PDSCH repetitions.

In some aspects, the BS 110 may transmit, and the UE 120 may receive, the PDCCH repetitions and the PDSCH repetitions without using a frequency hopping pattern. For example, the PDCCH repetitions and the PDSCH repetitions may be transmitted by the BS 110, and received by the UE 120, in a same channel (e.g., narrowband channel). As another example, such as when the PDCCH repetitions and the PDSCH repetitions are not multiplexed, the PDCCH repetitions may be transmitted by the BS 110, and received by the UE 120, in a first channel (e.g., a first narrowband channel) and the PDSCH repetitions may be transmitted by the BS 110, and received by the UE 120, in a second channel (e.g., a second narrowband channel).

In some aspects, the BS 110 may transmit, and the UE 120 may receive, the PDCCH repetitions and the PDSCH repetitions using a frequency hopping pattern. In some aspects, the BS 110 may transmit, and the UE 120 may receive, the PDCCH repetitions and the PDSCH repetitions using the same frequency hopping pattern. For example, the PDCCH repetitions may be transmitted by the BS 110, and received by the UE 120, according to a frequency hopping pattern for PDCCH repetitions (e.g., a frequency hopping pattern identified by the PDCCH configuration) and the PDSCH repetitions may be transmitted by the BS 110, and received by the UE 120, according to the frequency hopping pattern for PDCCH repetitions (e.g., using the same resources as the PDCCH repetitions). In such a case, the configuration may indicate that the UE 120 is to receive the PDSCH repetitions using the same frequency hopping pattern for which the UE 120 is configured for receiving PDCCH repetitions.

In some aspects, such as when the PDCCH repetitions and the PDSCH repetitions are not multiplexed, the BS 110 may transmit, and the UE 120 may receive, the PDCCH repetitions and the PDSCH repetitions using different frequency hopping patterns. For example, the PDCCH repetitions may be transmitted by the BS 110, and received by the UE 120, according to a first frequency hopping pattern for PDCCH repetitions (e.g., a frequency hopping pattern identified by the PDCCH configuration) and the PDSCH repetitions may be transmitted by the BS 110, and received by the UE 120, according to a second frequency hopping pattern for PDSCH repetitions (e.g., a frequency hopping pattern identified by the configuration, and not indicated by the one or more PDCCH repetitions). In some aspects, the configuration may indicate that the second frequency hopping pattern is to be determined using an offset relative to the first frequency hopping pattern. The offset may be a numerical offset relating to channel identifiers, a frequency offset relating to a channel frequency (e.g., a center frequency), and/or the like.

As shown by reference number 540, the UE 120 may process the PDCCH repetitions and/or the PDSCH repetitions. For example, the UE 120 may process the PDCCH repetitions and/or the PDSCH repetitions in an offline mode of the UE 120. In some aspects, the UE 120 may begin to process, according to the offline mode procedure, one or more first PDCCH repetitions and/or one or more first PDSCH repetitions received by the UE 120, while continuing to receive, in the online mode, one or more second PDCCH repetitions and/or one or more second PDSCH repetitions. For example, the UE 120 may begin to process, according to the offline mode procedure, the first PDCCH repetitions and/or the first PDSCH repetitions when a quantity of the first PDCCH repetitions and/or the first PDSCH repetitions, received by the UE 120, satisfies a threshold value.

In some aspects, in the offline mode, the UE 120 may perform a warm-up operation using the PDCCH repetitions and/or the PDSCH repetitions (e.g., the PDCCH repetitions and/or the PDSCH repetitions received by the UE 120 in an online mode and stored in a memory of the UE 120). According to the warm-up operation, the UE 120 may latch to a particular frequency and/or timing used by the B S 110, perform automatic gain control operations, perform channel estimation operations, and/or the like, to enable the UE 120 to process (e.g., decode) the PDCCH repetitions (e.g., the MPDCCH repetitions). In some aspects, in the offline mode, the UE 120 may decode the PDCCH repetitions (e.g., the PDCCH repetitions received by the UE 120 in an online mode and stored in a memory of the UE 120) to obtain the control information. The control information may provide information (e.g., an MCS, a data size, and/or the like) that enables the UE 120 to process (e.g., decode) the PDSCH repetitions. In some aspects, in the offline mode, the UE 120 may decode the PDSCH repetitions (e.g., the PDSCH repetitions received by the UE 120 in an online mode and stored in a memory of the UE 120) to obtain the paging message. The paging message may indicate that the UE 120 is to obtain particular system information, and the UE 120 may obtain the particular system information according to the paging message.

In this way, the UE 120 may conserve power resources by processing PDCCH repetitions (e.g., MPDCCH repetitions) and PDSCH repetitions in an offline mode, which is not possible in current wireless communication systems. Moreover, the UE 120 can process (e.g., decode) the PDCCH repetitions with improved efficiency because a portion of the control information of the PDCCH repetitions (e.g., a portion of the control information relating to a location of the PDSCH repetitions) is known to the UE 120 from the configuration.

As indicated above, FIG. 5 is provided as an example. Other examples may differ from what is described with respect to FIG. 5.

FIG. 6 is a diagram illustrating an example process 600 performed, for example, by a UE, in accordance with various aspects of the present disclosure. Example process 600 is an example where a UE (e.g., UE 120 and/or the like) performs operations associated with an offline discontinuous reception procedure.

As shown in FIG. 6, in some aspects, process 600 may include receiving a configuration that identifies one or more narrowband channels for receiving one or more PDSCH repetitions of a paging message associated with a discontinuous reception procedure (block 610). For example, the UE (e.g., using antenna 252, DEMOD 254, MIMO detector 256, receive processor 258, controller/processor 280, and/or the like) may receive a configuration that identifies one or more narrowband channels for receiving one or more PDSCH repetitions of a paging message associated with a discontinuous reception procedure, as described above.

As further shown in FIG. 6, in some aspects, process 600 may include receiving, in an online mode, one or more MPDCCH repetitions of control information (block 620). For example, the UE (e.g., using antenna 252, DEMOD 254, MIMO detector 256, receive processor 258, controller/processor 280, and/or the like) may receive, in an online mode, one or more MPDCCH repetitions of control information, as described above.

As further shown in FIG. 6, in some aspects, process 600 may include receiving, in the online mode, the one or more PDSCH repetitions in the one or more narrowband channels identified by the configuration (block 630). For example, the UE (e.g., using antenna 252, DEMOD 254, MIMO detector 256, receive processor 258, controller/processor 280, and/or the like) may receive, in the online mode, the one or more PDSCH repetitions in the one or more narrowband channels identified by the configuration, as described above.

As further shown in FIG. 6, in some aspects, process 600 may include processing, in an offline mode, the one or more MPDCCH repetitions and the one or more PDSCH repetitions (block 640). For example, the UE (e.g., using controller/processor 280 and/or the like) may process, in an offline mode, the one or more MPDCCH repetitions and the one or more PDSCH repetitions, as described above.

Process 600 may include additional aspects, such as any single aspect or any combination of aspects described below and/or in connection with one or more other processes described elsewhere herein.

In a first aspect, the paging message is a broadcast message.

In a second aspect, alone or in combination with the first aspect, the one or more PDSCH repetitions are received in the one or more narrowband channels identified by the configuration based at least in part on at least one of transmitting an indication that the UE is capable of processing the one or more MPDCCH repetitions and the one or more PDSCH repetitions in the offline mode or receiving an indication that offline mode processing is supported.

In a third aspect, alone or in combination with one or more of the first and second aspects, the one or more MPDCCH repetitions are multiplexed with the one or more PDSCH repetitions.

In a fourth aspect, alone or in combination with one or more of the first through third aspects, the one or more MPDCCH repetitions and the one or more PDSCH repetitions are received in a same narrowband channel. In a fifth aspect, alone or in combination with one or more of the first through third aspects, the one or more MPDCCH repetitions and the one or more PDSCH repetitions are received in different narrowband channels, and the one or more narrowband channels in which the UE is to receive the one or more PDSCH repetitions are not indicated by the one or more MPDCCH repetitions. In a sixth aspect, alone or in combination with one or more of the first through fifth aspects, the one or more PDSCH repetitions are received in a first narrowband channel having a particular offset from a second narrowband channel in which the one or more MPDCCH repetitions are received.

In a seventh aspect, alone or in combination with one or more of the first through sixth aspects, the one or more MPDCCH repetitions and the one or more PDSCH repetitions are received according to a same frequency hopping pattern. In an eighth aspect, alone or in combination with one or more of the first through sixth aspects, the one or more MPDCCH repetitions and the one or more PDSCH repetitions are received according to different frequency hopping patterns, and a frequency hopping pattern for the one or more PDSCH repetitions is not indicated by the one or more MPDCCH repetitions. In a ninth aspect, alone or in combination with one or more of the first through eighth aspects, the one or more PDSCH repetitions are received according to a first frequency hopping pattern having a particular offset from a second frequency hopping pattern in which the one or more MPDCCH repetitions are received.

In a tenth aspect, alone or in combination with one or more of the first through ninth aspects, the one or more MPDCCH repetitions and the one or more PDSCH repetitions are processed in the offline mode based at least in part on a determination that a quantity of the one or more MPDCCH repetitions and a quantity of the one or more PDSCH repetitions both satisfy a threshold value. In an eleventh aspect, alone or in combination with one or more of the first through tenth aspects, the one or more MPDCCH repetitions and the one or more PDSCH repetitions are processed in the offline mode based at least in part on a determination that a quantity of the one or more MPDCCH repetitions satisfies a threshold value.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with various aspects of the present disclosure. Example process 700 is an example where a base station (e.g., BS 110 and/or the like) performs operations associated with an offline discontinuous reception procedure.

As shown in FIG. 7, in some aspects, process 700 may include transmitting a configuration that identifies one or more narrowband channels in which a UE is to receive one or more PDSCH repetitions of a paging message associated with a discontinuous reception procedure (block 710). For example, the base station (e.g., using controller/processor 240, transmit processor 220, TX MIMO processor 230, MOD 232, antenna 234, and/or the like) may transmit a configuration that identifies one or more narrowband channels in which a UE is to receive one or more PDSCH repetitions of a paging message associated with a discontinuous reception procedure, as described above.

As further shown in FIG. 7, in some aspects, process 700 may include transmitting one or more MPDCCH repetitions of control information (block 720). For example, the base station (e.g., using controller/processor 240, transmit processor 220, TX MIMO processor 230, MOD 232, antenna 234, and/or the like) may transmit one or more MPDCCH repetitions of control information, as described above.

As further shown in FIG. 7, in some aspects, process 700 may include transmitting the one or more PDSCH repetitions in the one or more narrowband channels identified by the configuration (block 730). For example, the base station (e.g., using controller/processor 240, transmit processor 220, TX MIMO processor 230, MOD 232, antenna 234, and/or the like) may transmit the one or more PDSCH repetitions in the one or more narrowband channels identified by the configuration, as described above.

Process 700 may include additional aspects, such as any single aspect or any combination of aspects described below and/or in connection with one or more other processes described elsewhere herein.

In a first aspect, the paging message is a broadcast message. In a second aspect, alone or in combination with the first aspect, the one or more PDSCH repetitions are transmitted to a group of UEs that have indicated offline mode processing capability.

In a third aspect, alone or in combination with one or more of the first and second aspects, the one or more PDSCH repetitions are transmitted in the one or more narrowband channels identified by the configuration based at least in part on at least one of transmitting an indication that the base station supports offline mode processing or receiving an indication that the UE is capable of processing the one or more MPDCCH repetitions and the one or more PDSCH repetitions in an offline mode.

In a fourth aspect, alone or in combination with one or more of the first through third aspects, the one or more MPDCCH repetitions are multiplexed with the one or more PDSCH repetitions.

In a fifth aspect, alone or in combination with one or more of the first through fourth aspects, the one or more MPDCCH repetitions and the one or more PDSCH repetitions are transmitted in a same narrowband channel. In a sixth aspect, alone or in combination with one or more of the first through fourth aspects, the one or more MPDCCH repetitions and the one or more PDSCH repetitions are transmitted in different narrowband channels, and the one or more narrowband channels in which the UE is to receive the one or more PDSCH repetitions are not indicated by the one or more MPDCCH repetitions. In a seventh aspect, alone or in combination with one or more of the first through sixth aspects, the one or more PDSCH repetitions are transmitted in a first narrowband channel having a particular offset from a second narrowband channel in which the one or more MPDCCH repetitions are transmitted.

In an eighth aspect, alone or in combination with one or more of the first through seventh aspects, the one or more MPDCCH repetitions and the one or more PDSCH repetitions are transmitted according to a same frequency hopping pattern. In a ninth aspect, alone or in combination with one or more of the first through seventh aspects, the one or more MPDCCH repetitions and the one or more PDSCH repetitions are transmitted according to different frequency hopping patterns, and a frequency hopping pattern for the one or more PDSCH repetitions is not indicated by the one or more MPDCCH repetitions. In a tenth aspect, alone or in combination with one or more of the first through ninth aspects, the one or more PDSCH repetitions are transmitted according to a first frequency hopping pattern having a particular offset from a second frequency hopping pattern in which the one or more MPDCCH repetitions are transmitted.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving a configuration that identifies one or more narrowband channels in which the UE is to receive one or more physical downlink shared channel (PDSCH) repetitions of a paging message associated with a discontinuous reception procedure;
receiving, in an online mode of the UE, one or more machine-type communication physical downlink control channel (MPDCCH) repetitions of control information;
receiving, in the online mode of the UE, the one or more PDSCH repetitions in the one or more narrowband channels identified by the configuration; and
processing, in an offline mode of the UE, the one or more MPDCCH repetitions and the one or more PDSCH repetitions.

2. The method of claim 1, wherein the paging message is a broadcast message.

3. The method of claim 1, wherein the one or more PDSCH repetitions are received in the one or more narrowband channels identified by the configuration based at least in part on at least one of transmitting an indication that the UE is capable of processing the one or more MPDCCH repetitions and the one or more PDSCH repetitions in the offline mode or receiving an indication that offline mode processing is supported.

4. The method of claim 1, wherein the one or more MPDCCH repetitions are multiplexed with the one or more PDSCH repetitions.

5. The method of claim 1, wherein the one or more MPDCCH repetitions and the one or more PDSCH repetitions are received in a same narrowband channel.

6. The method of claim 1, wherein the one or more MPDCCH repetitions and the one or more PDSCH repetitions are received in different narrowband channels, and
wherein the one or more narrowband channels in which the UE is to receive the one or more PDSCH repetitions are not indicated by the one or more MPDCCH repetitions.

7. The method of claim 1, wherein the one or more PDSCH repetitions are received in a first narrowband channel having a particular offset from a second narrowband channel in which the one or more MPDCCH repetitions are received.

8. The method of claim 1, wherein the one or more MPDCCH repetitions and the one or more PDSCH repetitions are received according to a same frequency hopping pattern.

9. The method of claim 1, wherein the one or more MPDCCH repetitions and the one or more PDSCH repetitions are received according to different frequency hopping patterns, and
wherein a frequency hopping pattern for the one or more PDSCH repetitions is not indicated by the one or more MPDCCH repetitions.

10. The method of claim 1, wherein the one or more PDSCH repetitions are received according to a first frequency hopping pattern having a particular offset from a second frequency hopping pattern in which the one or more MPDCCH repetitions are received.

11. The method of claim 1, wherein the one or more MPDCCH repetitions and the one or more PDSCH repetitions are processed in the offline mode based at least in part on a determination that a quantity of the one or more MPDCCH repetitions and a quantity of the one or more PDSCH repetitions both satisfy a threshold value.

12. The method of claim 1, wherein the one or more MPDCCH repetitions and the one or more PDSCH repetitions are processed in the offline mode based at least in part on a determination that a quantity of the one or more MPDCCH repetitions satisfies a threshold value.

13. A method of wireless communication performed by a base station, comprising:
transmitting a configuration that identifies one or more narrowband channels in which a user equipment (UE) is to receive one or more physical downlink shared channel (PDSCH) repetitions of a paging message associated with a discontinuous reception procedure;
transmitting one or more machine-type communication physical downlink control channel (MPDCCH) repetitions of control information; and
transmitting the one or more PDSCH repetitions in the one or more narrowband channels identified by the configuration.

14. The method of claim 13, wherein the paging message is a broadcast message.

15. The method of claim 13, wherein the one or more PDSCH repetitions are transmitted to a group of UEs that have indicated offline mode processing capability.

16. The method of claim 13, wherein the one or more PDSCH repetitions are transmitted in the one or more narrowband channels identified by the configuration based at least in part on at least one of transmitting an indication that the base station supports offline mode processing or receiving an indication that the UE is capable of processing the one or more MPDCCH repetitions and the one or more PDSCH repetitions in an offline mode.

17. The method of claim 13, wherein the one or more MPDCCH repetitions are multiplexed with the one or more PDSCH repetitions.

18. The method of claim 13, wherein the one or more MPDCCH repetitions and the one or more PDSCH repetitions are transmitted in a same narrowband channel.

19. The method of claim 13, wherein the one or more MPDCCH repetitions and the one or more PDSCH repetitions are transmitted in different narrowband channels, and
wherein the one or more narrowband channels in which the UE is to receive the one or more PDSCH repetitions are not indicated by the one or more MPDCCH repetitions.

20. The method of claim 13, wherein the one or more PDSCH repetitions are transmitted in a first narrowband channel having a particular offset from a second narrowband channel in which the one or more MPDCCH repetitions are transmitted.

21. The method of claim 13, wherein the one or more MPDCCH repetitions and the one or more PDSCH repetitions are transmitted according to a same frequency hopping pattern.

22. The method of claim 13, wherein the one or more MPDCCH repetitions and the one or more PDSCH repetitions are transmitted according to different frequency hopping patterns, and
wherein a frequency hopping pattern for the one or more PDSCH repetitions is not indicated by the one or more MPDCCH repetitions.

23. The method of claim 13, wherein the one or more PDSCH repetitions are transmitted according to a first frequency hopping pattern having a particular offset from a second frequency hopping pattern in which the one or more MPDCCH repetitions are transmitted.

24. A user equipment (UE) for wireless communication, comprising:
a memory; and
one or more processors operatively coupled to the memory, the memory and the one or more processors configured to:
receive a configuration that identifies one or more narrowband channels in which the UE is to receive one or more physical downlink shared channel (PDSCH) repetitions of a paging message associated with a discontinuous reception procedure;
receive, in an online mode of the UE, one or more machine-type communication physical downlink control channel (MPDCCH) repetitions of control information;
receive, in the online mode of the UE, the one or more PDSCH repetitions in the one or more narrowband channels identified by the configuration; and
process, in an offline mode of the UE, the one or more MPDCCH repetitions and the one or more PDSCH repetitions.

25. The UE of claim 24, wherein the paging message is a broadcast message.

26. The UE of claim 24, wherein the one or more PDSCH repetitions are received in the one or more narrowband channels identified by the configuration based at least in part on at least one of transmitting an indication that the UE is capable of processing the one or more MPDCCH repetitions and the one or more PDSCH repetitions in the offline mode or receiving an indication that offline mode processing is supported.

27. The UE of claim 24, wherein the one or more MPDCCH repetitions are multiplexed with the one or more PDSCH repetitions.

28. The UE of claim 24, wherein the one or more MPDCCH repetitions and the one or more PDSCH repetitions are received in a same narrowband channel.

29. The UE of claim 24, wherein the one or more MPDCCH repetitions and the one or more PDSCH repetitions are received in different narrowband channels, and
wherein the one or more narrowband channels in which the UE is to receive the one or more PDSCH repetitions are not indicated by the one or more MPDCCH repetitions.

30. The UE of claim 24, wherein the one or more PDSCH repetitions are received in a first narrowband channel having a particular offset from a second narrowband channel in which the one or more MPDCCH repetitions are received.

31. The UE of claim 24, wherein the one or more MPDCCH repetitions and the one or more PDSCH repetitions are received according to a same frequency hopping pattern.

32. The UE of claim 24, wherein the one or more MPDCCH repetitions and the one or more PDSCH repetitions are received according to different frequency hopping patterns, and
wherein a frequency hopping pattern for the one or more PDSCH repetitions is not indicated by the one or more MPDCCH repetitions.

33. The UE of claim 24, wherein the one or more PDSCH repetitions are received according to a first frequency hopping pattern having a particular offset from a second frequency hopping pattern in which the one or more MPDCCH repetitions are received.

34. The UE of claim 24, wherein the one or more MPDCCH repetitions and the one or more PDSCH repetitions are processed in the offline mode based at least in part on a determination that a quantity of the one or more MPDCCH repetitions and a quantity of the one or more PDSCH repetitions both satisfy a threshold value.

35. The UE of claim 24, wherein the one or more MPDCCH repetitions and the one or more PDSCH repetitions are processed in the offline mode based at least in part on a determination that a quantity of the one or more MPDCCH repetitions satisfies a threshold value.

36. A base station for wireless communication, comprising:
a memory; and
one or more processors operatively coupled to the memory, the memory and the one or more processors configured to:
transmit a configuration that identifies one or more narrowband channels in which a user equipment (UE) is to receive one or more physical downlink shared channel (PDSCH) repetitions of a paging message associated with a discontinuous reception procedure;
transmit one or more machine-type communication physical downlink control channel (MPDCCH) repetitions of control information; and
transmit the one or more PDSCH repetitions in the one or more narrowband channels identified by the configuration.

37. The base station of claim 36, wherein the paging message is a broadcast message.

38. The base station of claim 36, wherein the one or more PDSCH repetitions are transmitted to a group of UEs that have indicated offline mode processing capability.

39. The base station of claim 36, wherein the one or more PDSCH repetitions are transmitted in the one or more narrowband channels identified by the configuration based at least in part on at least one of transmitting an indication that the base station supports offline mode processing or receiving an indication that the UE is capable of processing the one or more MPDCCH repetitions and the one or more PDSCH repetitions in an offline mode.

40. The base station of claim 36, wherein the one or more MPDCCH repetitions are multiplexed with the one or more PDSCH repetitions.

41. The base station of claim 36, wherein the one or more MPDCCH repetitions and the one or more PDSCH repetitions are transmitted in a same narrowband channel.

42. The base station of claim 36, wherein the one or more MPDCCH repetitions and the one or more PDSCH repetitions are transmitted in different narrowband channels, and
wherein the one or more narrowband channels in which the UE is to receive the one or more PDSCH repetitions are not indicated by the one or more MPDCCH repetitions.

43. The base station of claim 36, wherein the one or more PDSCH repetitions are transmitted in a first narrowband channel having a particular offset from a second narrowband channel in which the one or more MPDCCH repetitions are transmitted.

44. The base station of claim 36, wherein the one or more MPDCCH repetitions and the one or more PDSCH repetitions are transmitted according to a same frequency hopping pattern.

45. The base station of claim 36, wherein the one or more MPDCCH repetitions and the one or more PDSCH repetitions are transmitted according to different frequency hopping patterns, and
wherein a frequency hopping pattern for the one or more PDSCH repetitions is not indicated by the one or more MPDCCH repetitions.

46. The base station of claim 36, wherein the one or more PDSCH repetitions are transmitted according to a first frequency hopping pattern having a particular offset from a second frequency hopping pattern in which the one or more MPDCCH repetitions are transmitted.
